(19) United States
(12) Patent Application Publication
(10) Pub. No.: US 2005/0225287 A1
(43) Pub. Date: Oct. 13, 2005

(54) Desk lamp having charger for cellular phone

(75) Inventor: Oni Yang, Taipei (TW)

Correspondence Address: TROXELL LAW OFFICE PLLC, SUITE 1404, 5205 LEESBURG PIKE, FALLS CHURCH, VA, 22041, US

(73) Assignee: Ulike Corporation

(21) Appl. No.: 10/815,732

(22) Filed: Apr. 2, 2004

(51) Int. Cl. H02J 7/00

(52) U.S. Cl. 320/114

(57) ABSTRACT

A desk lamp comprises a recess formed on a base thereof, the recess including first contacts; a transformer formed within the base, the transformer being connected to the lamp in parallel and being operative to lower AC voltage; a circuit board formed inside the base, the circuit board including a charging circuit electrically connected to the first contacts, the charging circuit being operative to convert an AC voltage output from the transformer into DC voltage; and a charging seat snugly fitted in the recess, the charging seat including a phone compartment, a battery compartment, and second contacts. Coupling the contacts together will supply DC voltage to a first cellular phone disposed in the phone compartment and/or a chargeable battery of a second cellular phone disposed in the battery compartment for charging.

### BACKGROUND OF THE INVENTION

1. Field of the Invention

The present invention relates to chargers and more particularly to an improved desk lamp having a charger for cellular phone mounted thereon.

2. Description of Related Art

A conventional charger for cellular phone can be classified as travel charger, standard charger, or vehicle charger. Input voltages are the above chargers are different. For a travel charger, charging seat is not required since a cellular phone can be coupled thereto for charging. However, the cellular phone may malfunction after being charged. As such, most cellular phone users prefer to use a standard charger having a charging seat for charging. However, a cellular phone user may have to carry an adapter for charging his/her cellular phone when he/she travels to another country having a different rated voltage. This is not convenient. Also, it is observed that the standard charger is usually placed on a desk which in often times has a desk lamp placed thereon. This can make the desk crowded. Thus, it is desirable to provide a desk lamp having a charger for cellular phone in order to eliminate the need of adapter and save desk space.

### SUMMARY OF THE INVENTION

It is an object of the present invention to provide a desk lamp comprising a recess formed on a top surface of a base of the lap, the recess including a plurality of first contacts; a transformer formed within the base, the transformer being connected to the lamp in parallel and being operative to lower AC voltage; a circuit board formed inside the base, the circuit board including a charging circuit electrically connected to the first contacts, the charging circuit being operative to convert an AC voltage output from the transformer into DC voltage; and a charging seat shaped to snugly fit in the recess, the charging seat including a phone compartment, a battery compartment, and a plurality of second contacts formed on a side, whereby matingly coupling the second contacts to the first contacts will supply DC voltage to a first cellular phone disposed in the phone compartment and/or a chargeable battery of a second cellular phone disposed in the battery compartment for charging.

In one aspect of the present invention the charging circuit comprises a rectifier electrically coupled to the AC voltage output of the transformer for converting AC voltage into DC voltage; and a stabilizer electrically coupled to a DC voltage output of the rectifier for obtaining a stable DC voltage prior to supplying to the first contacts.

In another aspect of the present invention further comprises a socket formed on the base, the socket being electrically coupled to the first contacts; a charging cord including a first connector at one end; and a second connector for travel charger formed at the other end of the charging cord, whereby coupling the second connector for travel charger to a third cellular phone and inserting the first connector the socket will supply DC voltage from the charging circuit, the first contacts, and the socket to the third cellular phone for charging.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of desk lamp according to the invention;

FIG. 2 is an exploded perspective view of the desk lamp shown in FIG. 1; and

FIG. 3 is a schematic drawing of the lamp and charging circuit of the desk lamp.

### DETAILED DESCRIPTION OF THE PREFERRED EMBODIMENTS

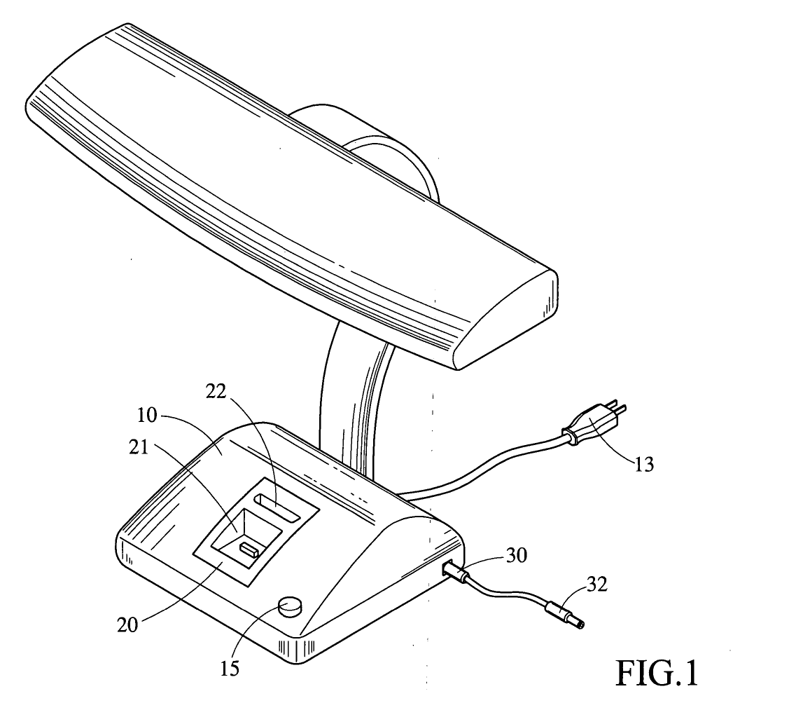

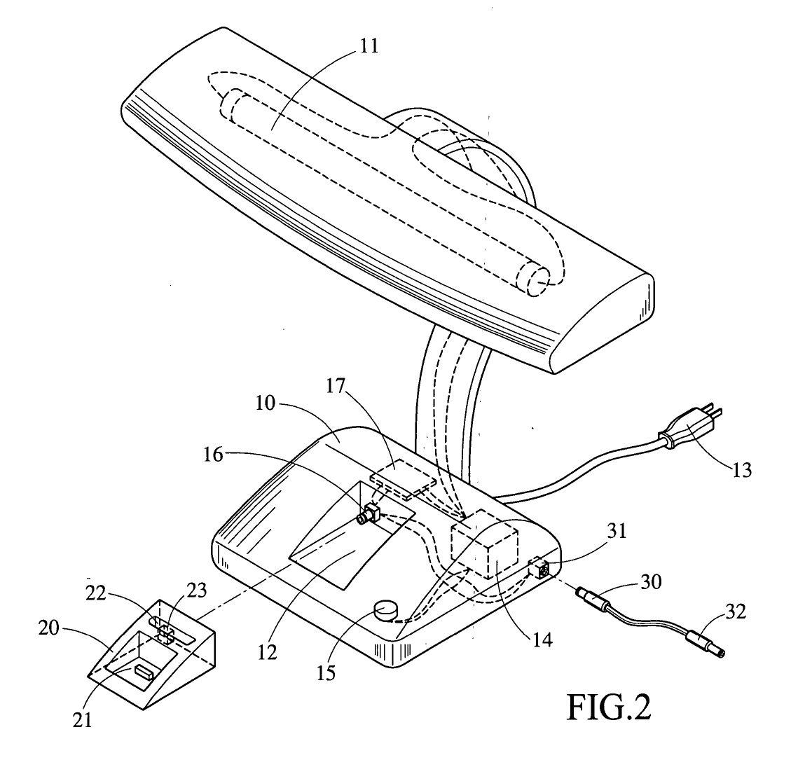

Referring to FIGS. 1 and 2, a desk lamp constructed in accordance with the invention is shown. The desk lamp comprises a base 10 and a lamp 11 covered by a shade. The lamp 11 is implemented as a fluorescent lamp, PL (phosphorescent lamp), or the like. A power cord 13 is extended from the base 10. A plug at the open end of the power cord 13 is adapted to insert into an outlet. The lamp 11 is electrically coupled to the power cord 13. A transformer 14 is provided within the base 10. The transformer 14 is also electrically coupled to the power cord 13 and is connected to the lamp 11 in parallel. An on-off switch 15 is provided on a corner of top surface of the base 10. The switch 15 is also electrically coupled to the transformer 14.

A recess 12 is provided on the top surface of the base 10. A plurality of first contacts 16 are formed on a wall of the recess 12. A circuit board 17 is provided inside the base 10. A charging circuit of the circuit board 17 is electrically interconnected the first contacts 16 and the transformer 14 for DC output by conversion. As such, rated voltage (i.e., AC) can be supplied to the transformer 14 for lowering voltage value through the power cord 13. The lowered AC voltage is then sent to the charging circuit of the circuit board 17 for converting into DC which is in turn fed to the first contacts 16 for being adapted to charge a discharged cellular phone as detailed below.

A charging seat 20 is shaped to snugly fit in the recess 12. The charging seat 20 comprises a phone compartment 21 for receiving a lower portion of a cellular phone so as to charge the cellular phone through a contact therein, and a battery compartment 22 for receiving a portion of a chargeable battery of the cellular phone so as to charge the battery through a contact therein. A plurality of second contacts 23 are provided on a side of the charging seat 20. The second contacts 23 are adapted to matingly couple to the first contacts 16 so that DC voltage can be supplied to a cellular phone and/or a battery for charging through the coupled contacts 16 and 23. Moreover, a socket 31 is formed on a side of the base 10. The socket 31 is electrically coupled to the first contacts 16. Further, a charging cord 30 is adapted to insert a connector formed at one end thereof into the socket 31. Furthermore, a connector for travel charger 32 is formed at the other end of the charging cord 30. The connector for travel charger 32 is adapted to couple to a cellular phone so that DC voltage can be supplied from the circuit board 17, the first contacts 16, and the socket 31 to a cellular phone for charging when the charging cord 30 is interconnected the socket 31 and the cellular phone.

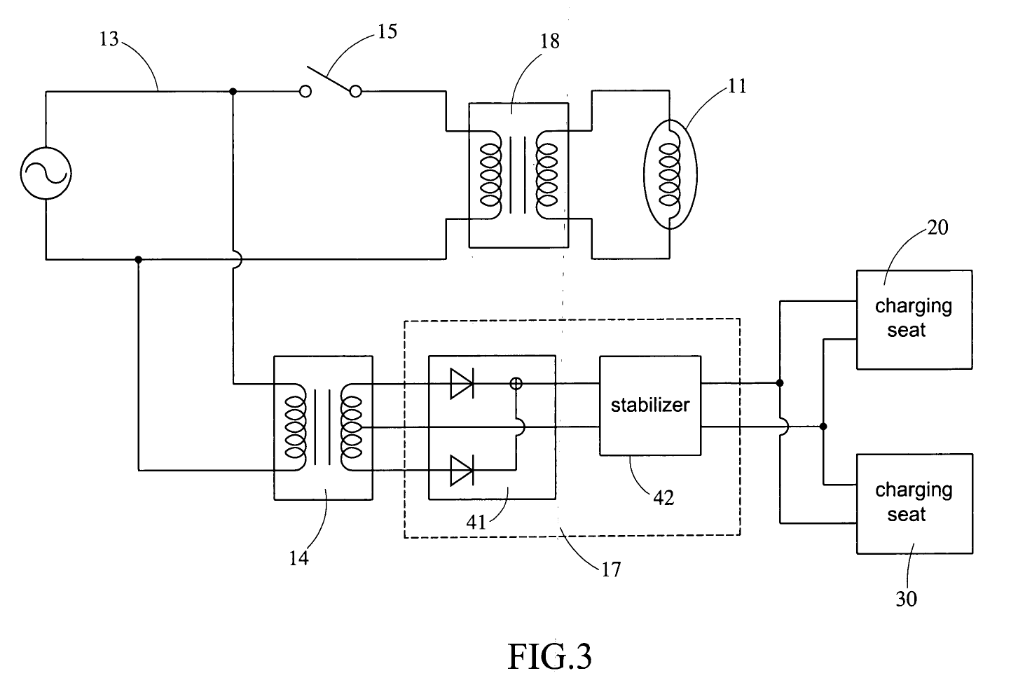

Referring to FIG. 3, there is shown a schematic drawing of the lamp and charging circuit of the desk lamp. A dimmer 18 is interconnected that lamp 11 and the switch 15 for adjusting luminance of the lamp 11. The transformer 14 is electrically coupled to the charging circuit of the circuit board 17 so that rated AC voltage can be lowered by the transformer 14. The transformer 14 can also be served as dimmer. The charging circuit comprises a rectifier 41 electrically coupled to AC output of the transformer 14 for converting AC into DC, and a stabilizer 42 electrically coupled to output of the rectifier 41 for smoothing DC voltage in order to obtain a stable one (e.g., in the range of 4V to 7V DC higher than 3.6V DC of the battery of a typical cellular phone). The stable charging voltage is then either fed to the first contacts 16 for charging a cellular phone and/or a battery of cellular phone on the charging seat 20 or fed to the charging cord 30 for charging another cellular phone. While the invention herein disclosed has been described by means of specific embodiments, numerous modifications and variations could be made thereto by those skilled in the art without departing from the scope and spirit of the invention set forth in the claims.

1. A desk lamp, comprising:
a recess formed on a top surface of a base of the lamp, the recess including a plurality of first contacts;
a transformer formed within the base, the transformer being connected to the lamp in parallel and being operative to lower AC voltage;
a circuit board formed inside the base, the circuit board including a charging circuit electrically connected to the first contacts, the charging circuit being operative to convert an AC voltage output from the transformer into DC voltage; and
a charging seat shaped to snugly fit in the recess, the charging seat including a phone compartment, a battery compartment, and a plurality of second contacts formed on a side,
whereby matingly coupling the second contacts to the first contacts will supply DC voltage to a first cellular phone disposed in the phone compartment and/or a chargeable battery of a second cellular phone disposed in the battery compartment for charging.

2. The desk lamp of claim 1, further comprising:
a power cord extended from the base, the power cord being operative to insert into an outlet; and
an on-off switch formed on the base, the switch being electrically coupled to the transformer.

3. The desk lamp of claim 1, wherein the lamp is either a fluorescent lamp or a phosphorescent lamp.

4. The desk lamp of claim 1, wherein the charging circuit comprises:
a rectifier electrically coupled to the AC voltage output of the transformer for converting AC voltage into DC voltage; and
a stabilizer electrically coupled to a DC voltage output of the rectifier for obtaining a stable DC voltage prior to supplying to the first contacts.

5. The desk lamp of claim 1, wherein the phone compartment comprises a third contact for coupling to the first cellular phone, and the battery compartment comprises a fourth contact for coupling to the chargeable battery of the second cellular phone.

6. The desk lamp of claim 1, further comprising:
a socket formed on the base, the socket being electrically coupled to the first contacts;
a charging cord including a first connector at one end; and
a second connector for travel charger formed at the other end of the charging cord,
whereby coupling the second-connector for travel charger to a third cellular phone and inserting the first connector the socket will supply DC voltage from the charging circuit, the first contacts, and the socket to the third cellular phone for charging.
